(19) United States
(12) Patent Application Publication
(10) Pub. No.: US 2006/0274471 A1
(43) Pub. Date: Dec. 7, 2006

(54) Outside plant cable pair protectors

(75) Inventors: Rick Garrett, Greenacres, WA (US); Rob Jayne, Spokane, WA (US)

Correspondence Address: LEE & HAYES, PLLC, 421 W. RIVERSIDE AVE, STE 500, SPOKANE, WA, 99201, US

(73) Assignee: Telect, Inc., Liberty Lake, WA (US)

(21) Appl. No.: 11/273,934

(22) Filed: Nov. 15, 2005

Related U.S. Application Data
(60) Provisional application No. 60/687,629, filed on Jun. 3, 2005.

(51) Int. Cl. H02H 3/22

(52) U.S. Cl. 361/111

(57) ABSTRACT

Embodiments of a protector block which integrates interconnection and surge protection for equipment in a telecommunications infrastructure are presented herein.

### FIELD OF THE INVENTION

The present disclosure relates to protector blocks for mounting in a telecommunications equipment frame. More specifically, the disclosure relates to a protector block integrating interconnections and card based surge protection in a single chassis mountable in a telecommunications equipment housing.

### BACKGROUND

Equipment within a telecommunications infrastructure may be vulnerable to electrical surges. For instance, telecom equipment maintained in an outside plant cabinet might be damaged in an electrical surge caused by a lightning strike. Accordingly, surge protection devices may be provided within a telecommunications infrastructure to protect various equipment and devices.

Traditionally, gas tube type surge protection devices have been used in telecommunication infrastructure to protect telephony devices. As newer technologies, such as DSL, have developed the amount of cabling and speed of telecommunications signal transmission have also increased. Protection in higher speed transmissions requires a quicker reaction time for protective devices. Gas tube devices may not have sufficient reaction time to adequately protect high speed telecommunications infrastructures.

In addition, protection devices and in particular bulky devices like gas tube require additional space within telecommunications equipment housing, which limits the amount of telecommunications equipment a housing or site may hold. Traditional techniques may also use individual protection devices for each circuit further increasing required space. Generally, more space is more costly due to rental cost, lease cost, taxes and so forth. Further, protection devices are traditionally provided separately from interconnection devices such as terminal blocks. Thus, it may be difficult, if not practically impossible to make pre-wired connections between components, such as terminal blocks, and surge protection devices, utilizing traditional techniques.

Accordingly traditional techniques for providing surge protection in a telecommunication infrastructure may provide inadequate protection, add cost due to more required space, and limit the ability to make pre-wired connections.

### SUMMARY

A protector block is described which integrates equipment termination and interconnections, and surge protection in a single chassis mountable in telecommunications equipment housing. The protector block includes a plurality of terminations configured to interconnect a plurality of network elements in a telecommunications infrastructure. A plurality of surge protections cards are insertable in the chassis to protect interconnected network elements from electrical surges. For example, each of the plurality of terminations may be connected to one of the plurality of surge protection cards, such that a signal pathway is formed via the surge protection card to connect at least two network elements in telecommunications infrastructure. Thus, the protector block provides capability to interconnect a plurality of network elements and provide surge protection in a single chassis.

### BREIF DESCRIPTION OF THE DRAWINGS

FIG. 1 is an illustration of an environment having a portion of a telecommunications infrastructure in which protector block may be employed.

FIG. 2 illustrates a protector block of FIG. 1 in an exemplary implementation in greater detail.

FIGS. 3A to 3C illustrate another protector block of FIG. 1 in an exemplary implementation in greater detail.

FIGS. 4A to 4B illustrate an exemplary surge protection card of FIGS. 3A-3C in greater detail.

FIG. 5 is a flow diagram depicting the forming of a protector block integrating interconnection and surge protection of network elements.

### DETAILED DESCRIPTION

It should be noted that the following devices are examples and may be further modified, combined and separated without departing from the spirit and scope thereof.

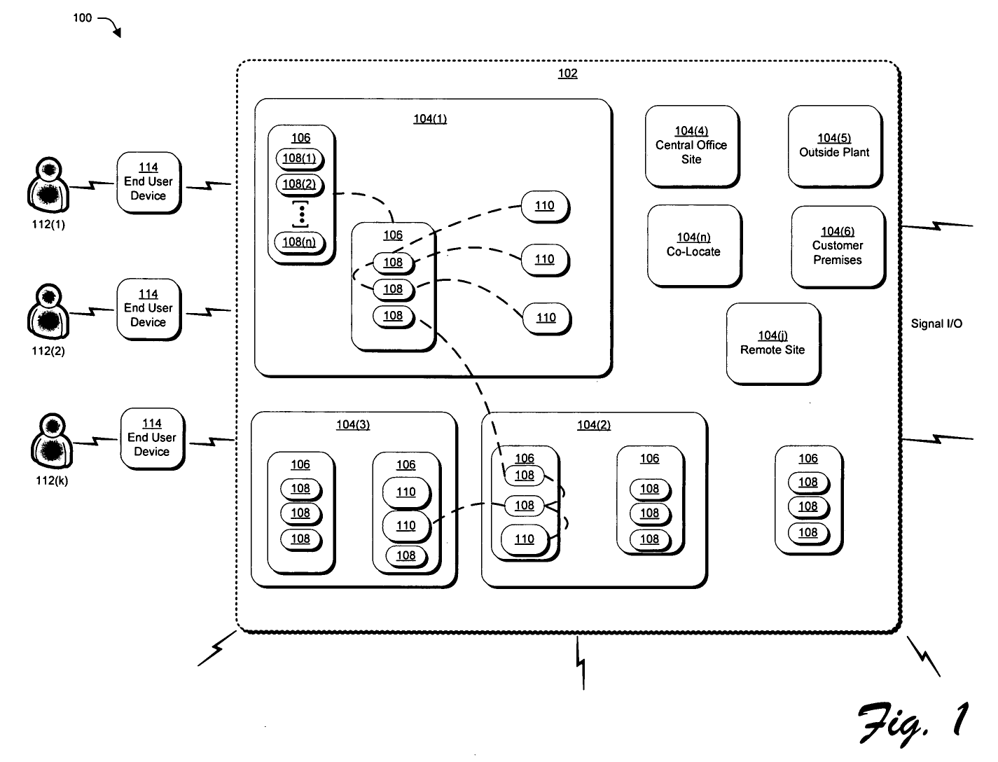

FIG. 1 illustrates an exemplary implementation of an environment 100 operable to provide a telecommunications network in which the apparatuses and procedures of the present disclosure may be employed. The environment 100 includes at least a portion of a telecommunication network infrastructure 102 (hereinafter “infrastructure”). Infrastructure 102 provides telecommunications processes, structures, equipment and devices between end-user devices such as modems, phones, and so on used by end-users outside of the infrastructure 102 to communicate via a telecommunications network. Within infrastructure 102 a variety of equipment, apparatus and devices are utilized in routing, processing, and distributing signals. Telecommunications signals and data may among other actions be processed, switched, routed, tested, patched, managed, or distributed by various equipment in the infrastructure 102.

A variety of sites 104(1)-104(j) within infrastructure 102 may maintain various equipment used in the infrastructure 102, where “j” may be any integer from one to “J”. As depicted in FIG. 1, infrastructure 102 may have numerous sites 104 which may be different physical locations within infrastructure 102 such as a central office, an outside plant site, a co-locate site, a remote site, or customer premises. Sites 104 may be locations within infrastructure 100 which hold a variety of structures and equipment to facilitate processing and distributing of telecommunications signals. The equipment may be centralized in one site (e.g., site 104(1)) or dispersed throughout different sites 104 in infrastructure 102. In other words, interconnections may be made between various sites 104 in infrastructure 102, for example the connection denoted in FIG. 1 by a dashed line between site 104(1) and 104(2). Naturally, numerous interconnections between a plurality of sites 104 typically may be made.

Each site 104 may have one or more housings 106 having a plurality of components 108. A housing refers to a structure to maintain or hold a plurality of components 108 in infrastructure 102 and may be configured in a variety of ways. For example, the housing 106 may be configured as a housing for a cabinet, a terminal block, a panel, a protector block, a chassis, a digital cross-connect, a switch, a hub, a rack, a frame, a bay, a module, an enclosure, an aisle, or other structure for receiving and holding a plurality of components 108. Hereinafter, the terms housing and cabinet will be used for convenience to refer to the variety of structures in infrastructure 102 that may hold components 108. Housings 106 may be inside a building or housings may themselves be configured to be placed outside, e.g. an outside plant cabinet. Housings 106 may typically be configured to protect components 108 from environmental influences. The environment 100 of FIG. 1, for instance, depicts site 104(1) as having two housings (e.g., cabinets) 106, each having a plurality of components 108. Other housings 106 may be included throughout infrastructure 102 at sites 104, for example housings 106 depicted within site 104(2).

Components 108 are pieces of telecommunications equipment in infrastructure 102 that may be kept or maintained in a housing 106 (e.g., a cabinet) within the infrastructure 102. Components for example may be cross-connect panels, modules, terminal blocks, protector blocks, chassis, backplanes, switches, digital radios, repeaters and so forth. Generally, components 108 may be those devices utilized for processing and distributing signals in infrastructure 102 and which may be maintained in a housing 104. Components 108 may also be used to manage cabling in infrastructure 102. Components 108 may terminate, interconnect or cross-connect a plurality of network elements 110 within infrastructure 102. Components 108 may be utilized to distribute telecommunications signals sent to and from infrastructure 102 by one or more end-users 112 using an end-user device 114. The interconnections between telecommunications equipment (e.g., cabinets 106, components 108 and network elements 110) provide signal pathways for telecommunications signals. Interconnection may be via one or more components 108 such as by connectors disposed on a component, such as a protector block, or may be internal to the components 108 such as via cabling within a component 108. Representative interconnections are shown by dashed lines in FIG. 1 and numerous interconnections within and between telecommunication equipment are typical.

Network elements 110 may be implemented in a variety of ways. For example, network elements 110 may be configured as switches, digital cross connect system (DCS), telecommunication panels, terminal blocks, protector blocks, digital radios, fiber optic equipment, network office terminating equipment, and any other telecommunication equipment or devices employed in a telecommunications infrastructure 102. It is noted that one or more of the components 108 within a cabinet 106 may also be a network element 110. In other words, network elements 110 may be found within a cabinet 106 as component 108 of the cabinet. Thus, in a particular cabinet 106 interconnections may be between network elements 110 externally (e.g., not in the same cabinet) or internally (e.g., within the same cabinet). Naturally, internal and external interconnections may be mixed such that a single cabinet 106 will have both internal and external interconnections. Further, such connections for a particular cabinet 106 might be made wholly within a particular site 104. Interconnections may also be made between a plurality of sites 104.

The environment 100 depicts a plurality of end users 112(1)-112(k), where “k” may be any integer from one to “K”. End users 112(1)-112(k) may be communicatively coupled, one to another, via a telecommunication network including infrastructure 102. End users 112 may be implemented in a wide variety of ways, such as consumers, business users, internal users in a private network, and other types of users that use telecommunications signals or transmit and receive telecommunications signals. Additionally, for purposes of the following discussion clients 112(1)-112(k) may also refer to client devices and software which are operable to transmit and receive telecommunications signals. Thus, clients 112(1)-112(k) may be implemented as users, software and devices.

The interconnection of pieces of equipment (e.g. cabinets 106, components 108 and network elements 110, and so forth) provides signal pathways between equipment for signals input to and output from infrastructure 102. For example, end-users 112(1)-112(k) may send signals into the infrastructure 102 and receive signals output from the infrastructure using a variety of end user devices 114. For example, end user 112(2) may communicate with end user 112(k) via end-user device 114 (e.g., a telephone). Thus, signals sent to and from infrastructure by end-users 112 via an end user device 114, may be routed directed, processed, and distributed in a variety of ways via the equipment and interconnections within infrastructure 102.

In an implementation, one or more cabinets 106 may be configured as distribution frame such as a main distribution frame (MDF) or intermediate distribution frame (IDF). A distribution frame has a plurality of components 108. Typically, components 108 in a distribution frame distribute telecommunications signals between network elements 110 within infrastructure 102 and between end-users 112. A distribution frame may provide a centralized interconnection point, for example in a telephone system or digital subscriber line system which provides service to end-users 112, and having equipment for terminating and interconnecting end-user lines (e.g. subscribers). The distribution frame is used to connect end-users lines, one to another, or to connect end user lines through network elements 110 in infrastructure 102. The distribution frame in a site 104 may also holds protective devices and act as a test point between end-users 112 and equipment in infrastructure 102.

In another implementation, a cabinet 106 may be configured for application at an outside plant site such as site 104(5) depicted in FIG. 1. In other words, the cabinet 106 may be an outside plant cabinet. An outside plant cabinet, as the name suggests, is located outside and is configured to protect a plurality of components 108, from environmental influences (e.g., heat, cold, wind, rain and so forth). Naturally, protecting components 108 from electrical surges is a particular concern in an outside plant application where damage due to lightning strikes is more likely. While outside plant applications may be particularly suited for the surge protection devices and techniques described herein, it may be appreciated that the devices and techniques may also be applied in other applications such as in an indoor cabinet or housing 106, at a central office site 104(4) and so forth.

In an implementation, a cabinet 106 has a plurality of components 108 to connect numerous lines. A cabinet 106 may have a plurality of components 108 configured as protector blocks, as depicted in FIG. 1 by protection blocks 108(1), 108(2), . . . , 108(n), where “n” may be any integer from one to “N”. Protector blocks 108(1)-108(n) provide modular connection points within a cabinet 106 between various network elements 110 such as switches, cross-connects, terminal blocks, other protector blocks and so forth. End-users 112 may be connected via twisted pair cabling to protector blocks 108(1)-108(n) in a cabinet 106 located within infrastructure 102. Further, end-users 112 may be connected via a plurality of network elements 110 which are connected via the various equipment in infrastructure 102, including the interconnections of a plurality of protector blocks such as protector blocks 108(1)-108(n). For example, an end-user telephone call made between end user 112(1) and end user 112(2) may be routed using one or more protector blocks 108(1)-108(n) and/or various network elements 110 within infrastructure 102.

Further protector blocks 108(1)-108(n) have integrated surge protection devices through which signal pathways between network elements 110 connected to the protector blocks 108(1)-108(n) are routed. In this manner, a protector block 108 provides protection from electrical surges to network elements 110 interconnected via the protector block 108. Thus, in addition to providing an interconnection point for a plurality of network elements 110 in infrastructure 102, protector blocks 108(1)-108(n) also provide integrated protection from electrical surges to the network elements 110. Naturally, protector blocks 108(1)-108(n) are representative of numerous protector blocks which may be found in numerous cabinets 106 within infrastructure 102.

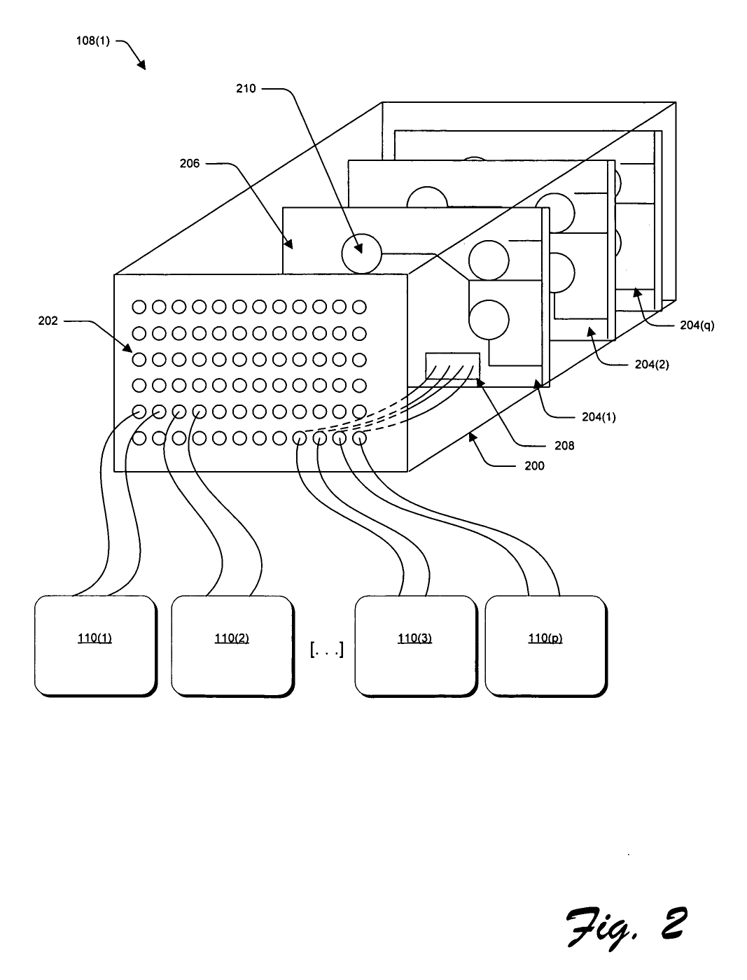

FIG. 2 is an illustration of protector block 108(1) of FIG. 1 in an exemplary implementation in greater detail. Protector block 108(1) is depicted as including a chassis 200. Chassis 200 may be configured in a variety of ways. For instance, chassis may be configured to be mountable in a housing 106. The chassis 200 may be configured to mount in one or both of standard sized 19 inch and 23 inch equipment housings. Thus, the chassis 200 may configured to be compatible with existing standard size equipment housings commonly employed in the telecommunication industry. Naturally, non-standard sized chassis and/or mountings may also be used in implementations. Chassis 200 as depicted in FIG. 2 has a substantially rectangular cross section. Other shapes of chassis 200 are also contemplated, such as square, triangular, oval and so forth. Chassis 200 may be formed from a variety of materials such as plastic, metal and so forth.

The interior of chassis 200 may be substantially open. The open interior of chassis 200 permits cabling to be run within the protector block 108(1) to make connections to parts of the protector block 108(1) and may provide a location for insertion of surge protector cards as described further below. Chassis 200 may further include a variety of different integrated cable routing mechanisms to route cabling, such as twisted pair cabling, ribbon cables, coaxial lines, and so forth within and around the chassis 200.

Importantly, the protector block 108(1) integrates the ability to interconnect a plurality of network elements 110 within infrastructure (e.g. via twisted pair or other cabling) and protection of the network elements from electrical surges in a single chassis 200. Thus, chassis 200 in FIG. 2 is depicted having a plurality of terminations 202 and a plurality of surge protection cards 204(1)-204(q), within the chassis 200, where “q” may be any integer from one to “Q”. FIG. 2 also depicts a plurality of network elements 110(1)-110(p), where “p” may be any integer from one to “P connected to protector block 108(1) via the terminations 202.

Terminations 202 provide interconnection points in a protector block 108(1) for signals pathways into and out from the protector block 108(1), e.g., transmit and receive signals. Thus, terminations 202 may permit a variety of interconnections between network elements 110(1)-110(p). The network elements 110(1)-110(p), when connected one to another, form a plurality of telecommunication circuits. A telecommunication circuit refers to interconnection (e.g., cross-connection) of at least two network elements 110(1)-110(p). Thus, protector block 108(1) is configured via terminations 202 to form a plurality of circuits. For instance, FIG. 2 depicts a circuit formed between network elements 110(3) and 110(p) via terminations 202 of protector block 108(1). Another circuit may be formed between network elements 110(1) and 110(2) and so on.

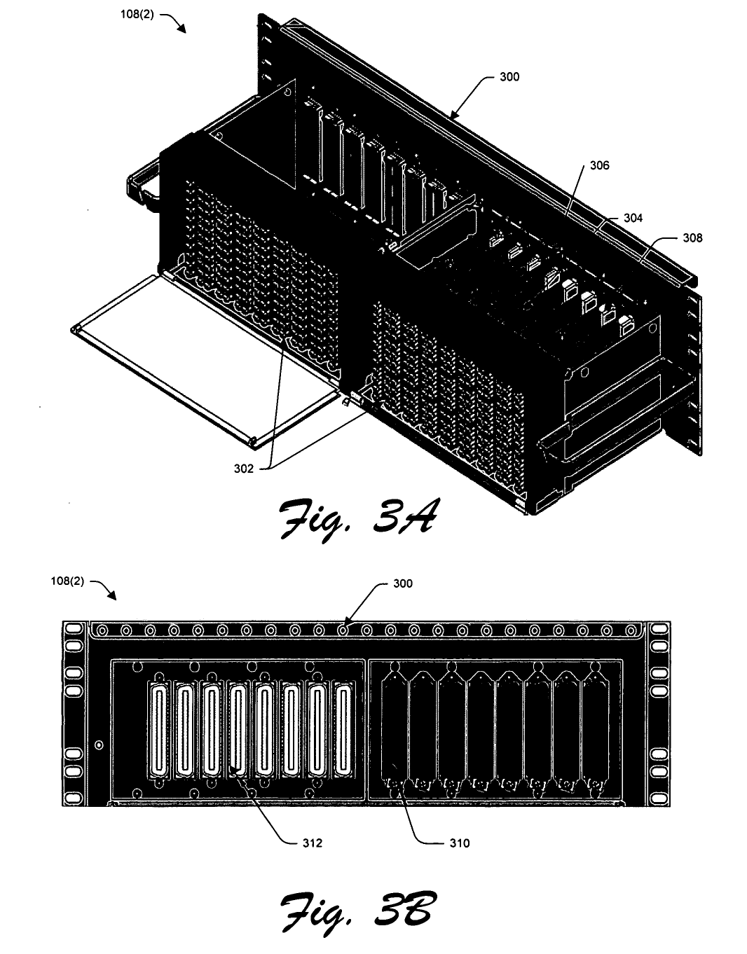

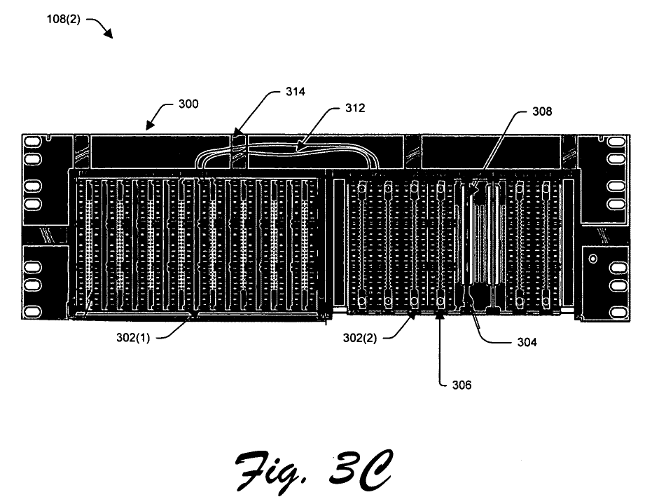

The chassis 200 has an array of terminations 202 disposed upon at least one surface of chassis 200 such that the terminations 202 extend through chassis 200 and are supported by the chassis. Terminations may be configured in a variety of ways, such as single post pins, bifurcated pins, insulation displacement connectors, screw terminals and so forth. It is also noted that one or more connectors, such as standard 50 pin or 64 pin connectors, may be used in place of or in conjunction with some or all the terminations 202 to provide the interconnection of network elements 110. Further discussion of connectors used with a protector block 108 for the interconnection of network elements 110 may be found in relation to FIG. 3B.

Although FIG. 2 depicts terminations 202 upon a single surface of chassis 200, in other implementations terminations 202 may also be disposed on multiple surfaces of chassis 200. For instance, network element 110(3) may be connected to terminations 202 as depicted in FIG. 2. Network element 110(4) may be connected to another set of terminations disposed on another surface of chassis 200. In this instance, the two network elements 110(3) and 110(4) may be interconnected via protector block 108(1), and more specifically via one of the plurality of surge protection cards 204(1)-204(q). In this manner, a circuit is formed between network elements 110(3) and 110(4) connected to protector block 108(1) via respective terminations on different surfaces of chassis 200.

The plurality of surge protection cards 204(1)-204(q) may be implemented in a variety of ways. Each surge protection card 204 may be formed from a substrate such as a printed circuit board 206, as depicted in FIG. 2. The printed circuit board 206 includes one or more interfaces 208 to connect the surge protection card 204 to a plurality of terminations 202. For example, surge protection card 204(1) in FIG. 2 is depicted as connected via interface 208 to a plurality of terminations 202 via cabling. Network elements 110(3) and 110(s) are depicted as connected to the same terminations 202. Signal pathways between network elements 110(3) and 110(s) are routed through the surge protection card 204(1) which may therefore provide protection from electrical surges to network elements 110(3) and 110(s). Again, it is noted that in an implementation terminations 202 may be arranged on multiple surfaces of chassis 200. In this implementation, one or more interfaces 208 of a surge protector card 204 may be configured accordingly to connect to terminations 202 on multiple surfaces of chassis 200.

Thus, network elements, such as network elements as 110(3) and 110(s), may be interconnected via the terminations through surge protection card 204(1). As noted, each such interconnection of network elements 110 is one telecommunication circuit. Further, each interface 208 is configured to connect a respective surge protection card 204 to many signal pathways of many circuits. Thus, each surge protection card 204 is configured to protect numerous circuits and corresponding network elements from electrical surges. In other words, numerous signal pathways corresponding to numerous circuits are routed through a single surge protection card 204.

Surges in a telecommunication infrastructure 102 may occur due to lightning strikes, power faults, malfunction, improper maintenance and so forth. Thus, surge protection cards 204(1)-204(q) are configured to provide protection from these electrical surges. Each surge protector card 204 is depicted having at least one surge protection mechanism 210 disposed on the respective printed circuit board 206. Typically a surge protection card 204 will include a plurality of surge protection mechanisms. Generally, surge protection mechanisms 210 eliminate or mitigate damage to equipment due to electrical surges, e.g., by cutting off the circuit, absorbing the surge, and so forth. Surge protection mechanisms 210 may include but are not limited to, metal oxide varistors, silicon avalanche diodes, fuses, solid state devices, and so forth. Surge protection mechanisms 210 may or may not be consumed by an electrical surge. Numerous surge protection mechanisms 210 of the same or different types maybe used, alone or combination, on the plurality of surge protection cards 204(1)-204(q).

In an implementation, each of the plurality of surge protection cards 204(1)-204(q) protects a plurality of circuits and has at least one surge protection mechanism 210 corresponding to each circuit protected by the respective surge protection card 204. In other words, each surge protection mechanisms 210 is configured to protect a single circuit. Thus, surge protection cards 204(1)-204(q) may have a one to one relationship between surge protection mechanisms 210 and circuits.

In another implementation, a single one of a plurality of surge protection mechanisms 210 disposed on a respective printed circuit board 206 protects numerous circuits. In other words, in a surge situation a single protection mechanism 210 is used to cut off the flow of many circuits, rather than having a one to one relationship between surge protection mechanisms 210 and circuits. For example, a single silicon avalanche diode disposed on surge protector card 204 may protect two or more circuits. Using surge protection mechanisms 210 in a one to many relationship may permit a greater number of circuits to be protected using less space within a chassis 200.

Thus, protector block 108(1) may protect a large number of circuits in a smaller design than using traditional techniques. A protector block having more circuit connections and/or protection for circuits for a given size is desirable, given the cost associated with additional equipment space (e.g., rent, taxes and so forth). Higher density products (more circuits per unit space of equipment housing) are continually sought. A protector block, such as protector block 108(1), having integrated interconnection and surge protection functions permit a higher density than traditional techniques.

FIGS. 3A-3C depict various views of another protector block 108(2) of FIG. 1 in an exemplary implementation in greater detail. Referring to FIG. 3A, protector block 108(2) has a chassis 300, a plurality of terminations 302, and plurality of surge protection cards 304 within chassis 300. Terminations 302 may be utilized to interconnect a plurality of network elements 110, forming a plurality of circuits via protector block 108(2). Signal pathways between the network elements 110 are formed through the plurality of surge protector cards 304, such that each surge protector card 304 protects a plurality of circuits and corresponding network elements 110 from electrical surges.

In an implementation, protector block 108(2) is configured to removably receive the plurality of surge protection cards 304. For instance, chassis 300 has a plurality of access points 306 corresponding to the plurality of surge protection cards 304. An access point 306 refers to a location within chassis 300 for receiving a surge protection card 304. The plurality of access points 306 may be configured with a variety of features such as a plurality of slots, guides, and/or connectors, clips, “snap-in” connectors, latches and so forth. These features may be used, alone or in combination, to removably receive and secure the plurality of surge protector cards 304 in the chassis 300. Accordingly, the surge protection cards 304 may slide, connect, or “snap” into place in chassis 300, and so forth, at a corresponding access point 306. Thus, surge protection cards 304 may be configured to be inserted and removed from the chassis 300 without using tools. In this way, the surge protector cards 304 are easily maintained or replaced by a technician or other user.

In an implementation, each access point 306 in chassis has a corresponding card edge connector 308. A plurality of card edge connectors are depicted in FIG. 3A arranged across an interior surface of chassis 300. Each of the plurality of card edge connectors 308 may engage a card edge one of the surge protector cards 304. The mating of the card edge connector 308 and the surge protector card 304, removably secures the surge protector card 304 in chassis 300. In this manner, surge protector cards 304 may be inserted and removed from the chassis 300 without using tools.

FIG. 3B illustrates another view of protector block 108(2) from the opposite side of chassis 300 as depicted in FIG. 3A. This view exposes a plurality of connectors disposed on the chassis 300. Connectors are used to connect incoming signal lines and outgoing signal lines to protector block 108(2). Each connector is configured to connect a plurality of network elements 110 to terminal block 108(2). Connectors may be arranged in one or more sets such as first set of connectors 310 and a second set of connectors 312 depicted in FIG. 3B. The sets of connectors 310 and 312 are used in conjunction with terminations 302 to interconnect network elements 110. Cabling, such as twisted pair cabling, may be used to make such connections. The network elements 110 connected to terminal block 108(2) via each set of connectors may then be interconnected in a various ways using terminations 302 as will be described in relation to FIG. 3C below.

The set of connectors 310 and 312 may be configured in a variety of ways. For example, the connectors may be 50 pin or 64 pin type connectors commonly used within the telecommunications industry. Connectors 310 and 312 may also be configured as various other types and sizes suitable for making interconnections of equipment (e.g., cabinets 106, components 108 and network elements 110) in a telecommunication infrastructure 102. It is noted that connectors 310 may be the same or different connectors than connectors 312.

Reference is now made to FIG. 3C which depicts a front on view of the terminations 302 of protector block 108(2). As is apparent in FIG. 3C, terminations 302 may include two sets of terminations 302(1) and 302(2). In FIG. 3C both sets of terminations are depicted as insulation displacement type terminations. However, it is noted that sets of terminations 302(1) and 302(2) may also be configured to be different.

FIG. 3C depicts termination sets 302(1) and 302(2) each generally disposed on one half of a surface of chassis 300. Although terminations sets may be arranged in this manner, the sets are defined by their function rather than by location or position on the chassis. For instance, terminations in set 302(1) are each configured to connect to one of connectors 308. Terminations in set 302(2) are configured to connect to one of the plurality of surge protection cards 304. These functions define the termination sets 302(1) and 302(2). Accordingly, termination sets 302(1) and 302(2) may be arranged in a variety of ways including different sets on each half of a surface of chassis 300, in alternating rows, in alternating terminations, and so forth.

As illustrated in FIG. 3C, cabling 314, such as twisted pair cabling, may be used to make interconnection between sets of terminations 302(1) and 302(2). Cabling 314 may be routed and managed around a protector block 108(2) by guides, such as guides 316 shown on chassis 300.

As previously described, the sets of terminations 302(1) and 302(2) are also connected respectively to connectors 310 and the plurality of surge protection cards 304. Further, each of surge protection cards 304 are coupled to a corresponding one of connectors 312. Accordingly, the interconnections of terminations 302(1) with 302(2) via cabling 314 provide a variety of signal pathways between sets of connectors 310 and 312. These interconnections form a plurality of circuits between network elements 110 connected to protector block 108(2) via connectors 310 and connectors 312, respectively. The signal pathways for each circuit are routed through one of surge protection cards 304, thereby protecting the corresponding network elements 110 from electrical surges.

It is noted that terminations 302(1) and 302(2) may be interconnected in a variety of ways to form different interconnections of network elements 110. Numerous interconnections represented in FIG. 3C by cabling 314, for instance, may be made between termination sets 302(1) and 302(2). These interconnections may be easily changed, maintained or disconnected. Thus, protector block 108(2) is capable of providing different interconnections of network elements 110 connected to connectors 310 and 312. Naturally, the particular network elements 110 connected to protector block 108(2) may also be changed, further increasing the variety of interconnections which may be made by the protector block 108(2).

In an implementation, protector block 108(2) may be configured to provide surge protection to circuits formed without the interconnection of terminations sets 302(1) and 302(2), one to another as just described. For instance, rather than forming interconnections of terminations 302 on the same protector block 108(2) (e.g., between sets 302(1) and 302(2)), terminations 302 may be connected to other equipment (cabinets 106, components 108, network elements 110). Circuits are formed between equipment connected to the terminations 302 and to a corresponding one of the plurality of connectors, through a respective surge protection card 304, which is coupled to both the terminations and a connector.

In this implementation, chassis 300 may have an access point 306 corresponding to each connector (e.g, each of connectors 310 and 312) and configured to receive a surge protection card 304. Thus, although the chassis 300 depicted in FIG. 3A shows surge protection cards 304 generally within half of the chassis 300, (e.g., corresponding to connectors 312) the entire interior of chassis 300 may be configured to receive surge protection cards 304. As an example, chassis 300 may be configured to hold sixteen surge protection cards 304 rather than the eight cards depicted in FIG. 3A. Circuits may then be formed and protected by a corresponding surge protection card 304 “straight-thru” protector block 108(2), e.g., without making interconnections between the terminations 302 on the protector block 108(2). A protector block 108(2) may be configured to provide entirely “straight-thru” protection. Alternatively, a protector block may be configured to provide a combination of “straight-thru” protection via some surge protection cards 304 of the plurality, and interconnected protection (e.g, using interconnections between the terminations 302) via other surge protection cards 304 of the plurality.

FIG. 3C also illustrates another aspect of protector block 108(2). All of the terminations 302 in FIG. 3C face the same direction such that protector block 108(2) provides “forward facing” access. In other words, routine operations may be performed from an exposed, “forward facing” side of the protector block 108(2). Accordingly, protector block 108(2) is mountable in a housing 106 such that the plurality of terminations 302 remain accessible. For instance, the side of chassis 300 illustrated in FIG. 3C remains accessible when mounted in a housing 106. Terminations 302 remain accessible to perform maintenance, to change the interconnections between sets of terminations 302(1) and 302(2), to disconnect an interconnection to discontinue service to an end-user, and so on. In this manner, interconnections between sets of terminations 302(1) and 302(2) previously described may be made, changed, and maintained conveniently from the “forward facing” side.

In addition, surge protector cards 304 may be inserted and removed from chassis 300, on the same side of chassis 300 as the terminations 302 (e.g., the “forward facing” side). FIG. 3C for instance shows a portion of terminations 302(2) removed at two access points 306, exposing surge protector cards 304 within chassis 300. Terminations 302, and in particular a portion of terminations of set 302(2), may be removably connected to an interface included on each of surge protector cards 304. Thus, the terminations 302(2) may be removed to permit insertion and removal of surge protector cards 304. With the terminations 302 removed, the surge protector cards 304 may be inserted and removed from chassis 300. Card edge connectors 308 are also depicted disposed along an interior wall of chassis 300. Card edge connectors 308 may correspond to connectors 312 of FIG. 3B. An inserted surge protection card 304 engages the card edge connector 308, thereby securing the surge protection card 304 to chassis 300 and coupling the surge protection card 304 to the corresponding connector 312. Thus, as depicted in FIG. 3C, protector block 108(2) provides access to perform routine operations such as interconnection and removable insertion of surge protection cards 304 on the “forward facing” side.

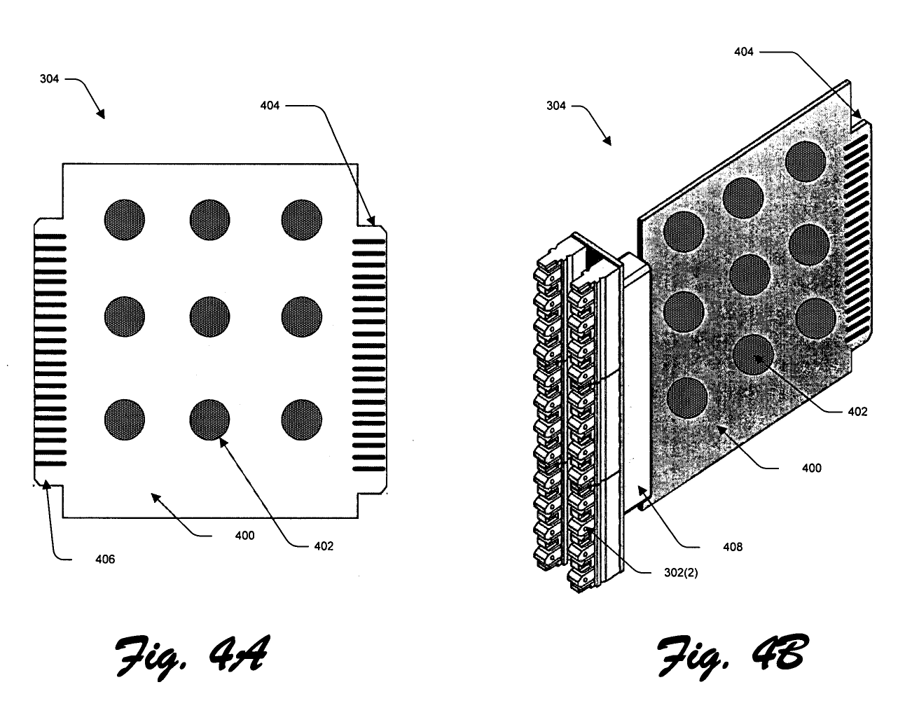

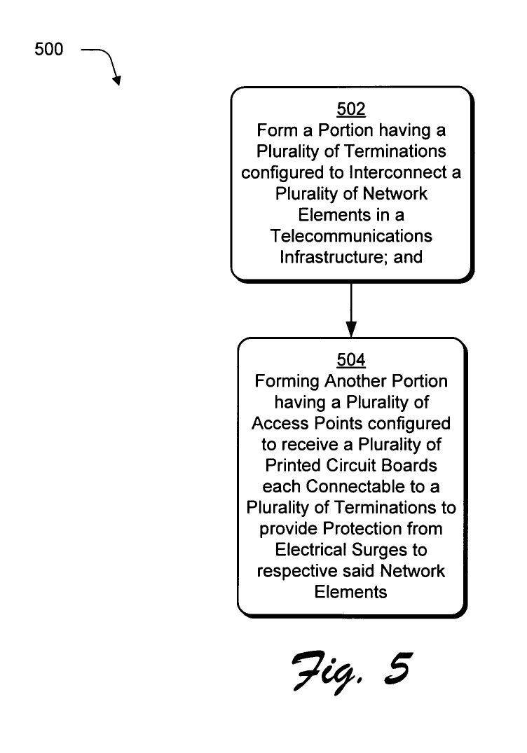

FIGS. 4A-4B depict one of the plurality of surge protection cards 304 of FIG. 3A in greater detail. FIG. 4A depicts surge protector card 304 having a printed circuit board 400. A plurality of surge protection mechanisms 402 is disposed on the printed circuit board 400. Surge protection mechanisms may be implemented in a variety of ways as previously described in reference to FIG. 2.

The printed circuit board 400 further includes an interface 404 on one edge. The interface 404 may be configured in a variety of ways, such as a pin connector, a card edge interface and so forth. In the implementation depicted in FIGS. 4A-4B, the interface 404 is a card edge interface. Interface 404 is configured to couple the surge protection card to a corresponding one of connectors 310. For instance, interface 404 may engage a card edge connector 308 corresponding to an access point 306 in chassis 300. Each access point 306 may include a corresponding card edge connector 308 to receive a corresponding card edge interface 404 of one of the surge protector cards 304. The mating of the card edge connector 308 and the card edge interface 404 removably secures the surge protector card 304 in chassis 300. In this manner, surge protector cards 304 may be inserted and removed from the chassis 300 without using tools. Further, the card edge connector 308 provides a coupling through the chassis 300 to a corresponding one of connectors 312. In another instance, the interface 404 may connect directly one of connectors 312 without a separate card edge connector 308.

FIG. 4A depicts another interface 406 included on another edge of printed circuit board 400. Again, the interface 406 may be configured in a variety of ways, such as a pin connector, a card edge interface and so forth. In FIG. 4B, interface 406 shown in FIG. 4A is depicted as having engaged a card edge connector 408 that provides a coupling to a plurality of terminations in the set of terminations 302(2). As previously described, a set of terminations 302(2) may be interconnected with a set of terminations 302(1) which are in turn connected to connectors 310. Thus, via interfaces 404 and 406, a variety of signal pathways between connectors 310 and connectors 312 may be created through a respective surge protection card 304.

A protector block 108 with a plurality of surge protector cards 304 may protect many circuits. In the implementation depicted in FIGS. 3A-3C, the chassis 300 of protector block 108(2) is depicted having a total of eight surge protector cards 304. Each surge protector card as depicted in FIG. 4A-4B is configured to protect 24 circuits. Thus, protector block 108(2) is configured to provide interconnections and surge protection for a total of 192 circuits. As previously described, in an implementation protector block 108(2) is configured to provide “straight-thru” protection using sixteen surge protector cards 304. In this implementation, a total of 384 circuits may be protected. Naturally, other implementations may provide more or less circuit capacity, by using a different chassis size, a different number or type of surge protection cards, and so forth.

Exemplary Procedures

The following discussion describes techniques that may be implemented utilizing the previously described systems and devices. The procedures are shown as a set of blocks that specify operations performed and are not necessarily limited to the orders shown for performing the operations by the respective blocks.

FIG. 5 is a flow diagram depicting a procedure 500 in an exemplary implementation in which a protector block integrating interconnection of network elements and card based surge protection of the network elements is formed. A portion is formed having a plurality of terminations configured to interconnect a plurality of network elements in a telecommunications infrastructure (block 502). For example, the terminations 302 of protector block 108(2) depicted in FIG. 3A may be formed. Terminations 302 may be used to form interconnections of a plurality of network elements 110 connected to terminal block 108(2) via set of connectors 310 and 312.

Another portion is formed having a plurality of access points each configured to receive one of a plurality of printed circuit boards connectable to a plurality of the terminations to provide surge protection to network elements (block 504). For instance, a plurality of access points 306 may be formed within chassis 300 of terminal block 108(2) depicted in FIG. 3A. Each access point 306 may receive a surge protection card 304 depicted in FIGS. 4A-4B. Access points 306 may include card guides and a card edge connector 308 disposed on the interior of chassis 300 to receive and secure a surge protection card 304 within chassis 300. A card edge interface 404 of FIG. 4A disposed on a printed circuit board 400 of the surge protection card 304, may engage the corresponding card edge connector 308 of the access point 306 to removably secure the card within the chassis 300. Each surge protection card 304 is further configured with another interface 406 to connect the card to a plurality of terminations, such as a portion of terminations 302(2) depicted in FIG. 3C.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A chassis comprising;
a plurality of terminations; and
a plurality of surge protections cards insertable within the chassis, wherein each termination of the plurality of terminations is configured to connect to a corresponding said surge protection card such that a signal pathway is formed via the surge protection card to connect at least two network elements in telecommunications infrastructure.

2. A chassis as recited in claim 1, wherein each said surge protector card is removably received within the chassis without tools.

3. A chassis as recited in claim 1, wherein each said surge protector card is implemented via a printed circuit board.

4. A chassis as recited in claim 1, wherein each surge protector card is configured to provide protection from electrical surges to at least twenty four telecommunication circuits.

5. A chassis as described in claim 1, wherein each surge protector card utilizes one or more surge protection mechanisms selected from the group consisting of:
a silicon avalanche diode (SAD);
a metal oxide varistor (MOV);
solid state devices; and
a fuse.

6. A chassis as recited in claim 1, further comprising a plurality of access points each configured to receive one of the plurality of surge protection cards.

7. A chassis as recited in claim 1, further configured to receive at least eight surge protection cards.

8. An apparatus comprising:
a chassis having an array of terminations disposed upon at least one wall of the chassis, wherein the terminations are configured to provide a plurality of signal pathways between network elements in a telecommunications infrastructure; and
a plurality of printed circuit boards, each of which:
is removably received within the chassis;
is connectable to a plurality of the terminations; and
protects a plurality of said network elements from electrical surges.

9. An apparatus as described in claim 8, wherein the plurality of terminations are selected from the group consisting of:
insulating displacement connectors (IDC), bifurcated wire wrap;
screw terminals; and
single post wire wrap.

10. An apparatus as described in claim 8, further comprising a first set of connectors and a second set of connectors disposed on the chassis, wherein:
each said connector is configured to connect a plurality of network elements to the chassis; and
each of the plurality of signal pathways is formed between one said connector of the first set and one said connector of the second set, and through one of the plurality of printed circuit boards.

11. An apparatus as described claim 8, wherein each said printed circuit board includes a first interface to connect to the plurality of terminations and a second interface to connect to a corresponding connector of a set of connectors disposed on the chassis.

12. An apparatus as described claim 8, wherein the array of terminations includes a first set of terminations and a second set of terminations which are configured to be interconnected, one to another, to form the plurality of signal pathways.

13. An apparatus as described in claim 10, wherein each said printed circuit board includes a plurality of surge protection mechanisms selected from the group consisting of:
a silicon avalanche diode (SAD);
a metal oxide varistor (MOV);
solid state devices; and
a fuse.

14. A surge protector block comprising:
a portion having a plurality of terminations configured to interconnect a plurality of network elements in a telecommunications infrastructure; and
another portion having a plurality of printed circuit boards, each connectable to one or more of the plurality of terminations to provide protection from electrical surges to respective said network elements.

15. A surge protector block as described in claim 14 wherein:
the plurality of terminations includes a first set of terminations and a second set of terminations; and
each interconnection of said plurality of network elements is formed through one said printed circuit board via at least one interconnection of a termination of the first set with a termination of the second set.

16. A surge protector block as described in claim 14, wherein the plurality of terminations face a direction and the plurality of printed circuit boards are removable via the direction.

17. A surge protector block as described in claim 14, wherein the portion having a plurality of printed circuit boards includes a plurality of access points configured to receive the plurality of printed circuit boards.

18. A surge protector block as described in claim 14 wherein each printed circuit board includes:
a plurality of surge protection mechanisms disposed on the printed circuit board; and
one or more interfaces configured to form signal pathways through the printed circuit board between a plurality of said network elements.

19. A method comprising:
forming a portion of a chassis to include a plurality of terminations configured to interconnect a plurality of network elements in a telecommunications infrastructure; and
forming another portion in the chassis to include a plurality of access points configured to receive a plurality of printed circuit boards, each said printed circuit board being connectable to one or more of the plurality of terminations to provide protection from electrical surges to respective said network elements

20. The method as recited in claim 19, further comprising:
interconnecting each of the plurality of terminations to a corresponding one of the plurality of printed circuit boards; and
removably inserting the plurality of printed circuit boards in the plurality of access points.
